(19) United States
(12) Patent Application Publication
(10) Pub. No.: US 2020/0103050 A1
(43) Pub. Date: Apr. 2, 2020

(54) Carrousel with water bearing

(71) Applicant: IHC Holland IE B.V., Sliedrecht (NL)

(72) Inventor: Kuno Johannes Alexander van den Berg, Delft (NL)

(73) Assignee: IHC Holland IE B.V., Sliedrecht (NL)

(21) Appl. No.: 16/617,519

(22) PCT Filed: Jun. 1, 2018
(86) PCT No.: PCT/NL2018/050361

§ 371 Date: Nov. 27, 2019

(30) Foreign Application Priority Data
Jun. 2, 2017 (NL) 2019014

(51) Int. Cl. F16L 1/20; B63B 35/03; B63B 35/04; H02G 1/10; B65H 49/28

(52) U.S. Cl. CPC F16L 1/203; B63B 35/03; B63B 35/04; H02G 1/10; B65H 2701/34; B65H 2402/351; B65H 2402/42; B65H 2402/525; B65H 49/28

(57) ABSTRACT

The invention relates to a cable turntable assembly for use in storing and laying long lengths of pipe or cable, comprising:
a rotatable turntable,
a turntable support surface supporting the turntable for rotational movement, and
a fluid bearing system between the rotatable turntable and the turntable support surface, the fluid bearing system comprising a pressurized fluid chamber and a sealing system comprising a sealing element extending at a circumference of the turntable to seal an annular gap at the outer circumference of the turntable.

### FIELD OF THE INVENTION

The present invention relates to a cable turntable assembly for use in storing and laying long lengths of pipe or cable, the cable turntable assembly comprising;
a rotatable turntable,
a turntable support surface supporting the turntable for rotational movement.

The present invention further relates to a vessel comprising a cable turntable assembly.

### BACKGROUND ART

A rotating turntable, also carrousel, on a barge or ship is configured for carrying cable or pipe. As an example, such a rotating turntable may have a weight of about 300 t and may carry a 5000 t stock of pipe or cable. The diameter of the rotating turntable may be 25 meter and 3 meter in height. Of course, other dimensions and a higher capacity are possible. In use, the carousel is capable of rotation around the vertical. The carousel is a donut shaped construction mounted on a large number of wheels. The carousel has an inner diameter corresponding to the minimum bending radius of the cable or pipe it carries and usually turns around a column at the centre of the carousel. This column usually also prevents the carousel from moving transversely with respect to the deck of the ship. The column is often referred to as “king pin”.

The support of the carousel on the deck of the barge or ship basically needs to have the following characteristics. Firstly, load needs to be distributed to the supporting deck since the barge or ship deck has stiffening at discrete locations by relatively low capacity stiffeners and higher capacity webs and girders. Secondly, since the deck of a barge or ship is not perfectly flat due to its construction and deformation, the supports needs to be able to accommodate these imperfections.

There are a few known solutions to support a carousel on the deck of a ship. A first solution is a large number of wheels below the carousel. The wheels have built in vertical flexibility or hydraulically operated movement to compensate for the vertically uneven supporting deck structure. It is also known to have a set of multiple discrete inflatable supports that can slide along the deck. Such a solution is known from U.S. Pat. No. 4,647,253. Also, it is known to place a basin on deck filled with water in which the carousel floats. This is shown in GB-384186 A and EP2085308 B1.

Lastly, U.S. Pat. No. 3,952,962 (A) relates to cable drums for laying submarine cable. In U.S. Pat. No. 3,952,962 the cable drum is penetrated from end to end by a central hole and is provided with means for supporting the drum in an up-ended position on a cushion of pressurised fluid. A flexible skirt of annular form is disposed around the periphery of what, in use, is the lower end of the drum so as to define a cushion space. A pressurised fluid is supplied to said cushion space by way of the said central hole.

These known solutions have their problems. The wheels or multiple supports are relatively expensive, and vulnerable because the support constructions cannot be reached in case of damage, especially when a stock of cable is present in the carousel. A floating carousel requires a very large basin to create enough water column for the carousel to float. This means that an expensive and heavy weight construction is necessary to support the basin. It also means that the carousel itself needs to be water-tight not only at the bottom of the carousel but also over the entire height dimension of the carousel, or at least a large part of the height dimension of the carousel.

The load bearing capacity of the cushion of U.S. Pat. No. 3,952,962 (A) is not sufficient in reality. Moreover, the skirt is hard to access and therefore it is hard to service or do maintenance. Thirdly, the cable drum of U.S. Pat. No. 3,952,962 (A) requires a spindle to support and bear the drum.

### SUMMARY OF THE INVENTION

The present invention has for its object to provide a cable turntable assembly that puts less demands on the supporting deck and is easier to maintain.

Another object of the current invention is to provide a solution for problems associated with known cable turntable assemblies.

A further object of the current invention is to provide an alternative cable turntable assembly.

According to the present invention, the object is achieved by a cable turntable assembly for use in storing and laying long lengths of pipe or cable, comprising:
a rotatable turntable,
a turntable support surface supporting the turntable for rotational movement, and
a fluid bearing system between the rotatable turntable and the turntable support surface, the fluid bearing system comprising a pressurized fluid chamber and a sealing system comprising a sealing element extending at a circumference of the turntable to seal an annular gap at the outer circumference of the turntable.

The fluid bearing system comprising a pressurized fluid chamber and a sealing system comprising a sealing element extending at a circumference of the turntable to seal an annular gap at the outer circumference of the turntable enables to have a fluid bearing that contacts the entire turntable. This results in an even load distribution on deck while avoiding expensive wheels or other supporting constructions below the turntable that are difficult to reach. With regard to the existing floating solutions, fluid bearing avoids a large heavy basin. In addition, sea-fastening during transport is easy. The fluid can be drained and the turntable then rests on the supporting surface.

The fluid is in particular water. The fluid bearing enables rotation of the turntable with a low friction. The fluid chamber is a defined confined space between the turntable, the support surface and the sealing element. The sealing element can be attached to the turntable, the support surface or both in case of an assembly a sealing elements.

Pressurized is to say that the fluid in the pressurized fluid chamber is put under pressure above atmospheric pressure by a pump or any suitable source of pressure. The fluid under pressure lifts the turntable to an active height position. The active height position of the turntable is between about 5 cm to up to about 30 cm above the deck of the barge or ship to create a clearance or gap between the turntable and the turntable support surface. The gap is sealed by the sealing system at the outer circumference of the turntable. The sealing system is accessible from the outside of the cable turntable assembly.

According to the invention, the annular gap extends between the outer circumference of the turntable and a watertight barrier that extends around the turntable and transverse with respect to the turntable support surface. This facilitates sealing of the annular gap while the turntable position lifts towards the active height position.

In an embodiment of the cable turntable assembly, the pressurized fluid chamber extends over at least 80% of the perpendicular to the horizontal plane projected surface of the turntable. This results in an even better load distribution on the supporting surface. As an example, in an embodiment of the cable turntable assembly without a king pin, the pressurized fluid chamber extends over 100% of the perpendicular to the horizontal plane projected surface of the turntable.

In an embodiment of the cable turntable assembly, the pressurized fluid chamber is sectioned. This enables to improve the reliability of the turntable in that the unwanted effects of a sudden loss of pressure in the fluid chamber can be reduced. Such a sectioned fluid chamber deflates more slowly. In a steady state, the pressure in different sections of the fluid chamber is the same.

In an embodiment, the cable turntable assembly comprises an inlet for supplying pressurized fluid to the pressurized fluid chamber. The inlet can be connected to the turntable, the turntable support surface or both in case of a number of inlets.

In an embodiment of the cable turntable assembly, the sealing element is dimensionally stable. This is in contrast with another conceivable sealing element, an inflatable sealing which dimensions depend on the applied load and supplied inflation pressure.

In an embodiment of the cable turntable assembly, the sealing system is connected to the turntable and/or the watertight barrier.

In an embodiment of the cable turntable assembly, a height of the pressurized fluid chamber is configured for accommodating deviations of the turntable support surface and the turntable. In particular, the height of the pressurized fluid chamber is between between about 5 cm to up to about 30 cm. This avoids contact between the turntable and the turntable support surface and assures frictionless rotation of the turntable. In other words, the height of the pressurized fluid chamber enables to accommodate movements of the turntable.

In an embodiment, the cable turntable assembly comprises a stop arrangement for maintaining a position of the turntable relative to the turntable support surface. This enables to maintain the position of the turntable. This may be beneficial to the functioning of the sealing system, in particular when the sealing system comprises an assembly of sealing elements.

In an embodiment of the cable turntable assembly, the stop arrangement comprises a number of axially working stop elements spatially distributed along the outer circumference of the rotatable turntable. As a result the turntable is prevented from continuing to move upward. Sealing contact of the sealing system is maintained. Also, the turntable cannot rotate out of plane, that is rotate around a horizontal axis, which means that sectioning of the fluid chamber is not required. Such a stop may for example be a flange, a slider, a wheel. The number of axially working stop elements define the active height position of the turntable when the pressurized fluid chamber is pressurized. When the fluid chamber is pressurized, the turntable sits at the active height position. Then, the turntable abuts the axially working stop elements.

In an embodiment of the cable turntable assembly, the stop arrangement comprises a number of radially working stop elements spatially distributed along the outer circumference of the rotatable turntable. A center column, also the king pin, is then not strictly required for absorbing transverse forces which results in a better distribution of loads to be counteracted in the deck and therefore locally lower loads. This is due to the fact that horizontal loads on the kingpin create a moment at deck level which needs to be counteracted over a relatively small footprint of the kingpin. Such a stop may for example be a flange, a slider, a wheel. The radially working stop elements are in particular arranged proximate the sealing element or elements. This way, outward deformation of the watertight barrier has less effect to the sealing function of the sealing system.

In an embodiment of the cable turntable assembly, the sealing system comprises a spacer between the turntable support surface and the turntable to set the operation of the sealing element. This enables to maintain a desired gap even if the pressure drops. This improves reliability and provides a safe fail.

In an embodiment of the cable turntable assembly, the sealing system comprises two sealing elements operating in series. This even more improves reliability of the cable turntable assembly.

In an embodiment, the cable turntable assembly comprises a driving system for rotating the turntable, wherein the driving system comprises a driving wheel. The driving system comprising a driving wheel enables to combine the function of driving and the stop arrangement. At least both a toothed wheel and a friction wheel are conceivable for a driving wheel.

In an embodiment, the cable turntable assembly comprises a bearing fluid recirculating system. This enables to collect a leakage flow of bearing fluid in a reservoir and reuse the collected fluid.

The invention further relates to a vessel comprising a cable turntable assembly. In an embodiment of the vessel, the turntable support surface comprises a deck of the vessel or barge, and/or an additional surface layer directly in contact with the deck of the vessel or barge. The additional surface layer would only serve as a sealing system to avoid fluid spillage, not as structural support of the turntable.

### SHORT DESCRIPTION OF DRAWINGS

The present invention will be discussed in more detail below, with reference to the attached schematic drawings, in which

FIG. 1 shows in perspective view a cable turntable assembly according to the invention,

FIG. 2 is detail of FIG. 1;

FIG. 3 is a side view of the cable turntable assembly of FIG. 1;

FIG. 4 detail of an embodiment of the sealing system;

FIG. 5a-c possible arrangements of sealing element(s); and

FIG. 6 a vessel comprising a cable turntable assembly according to the invention.

### DESCRIPTION OF EMBODIMENTS

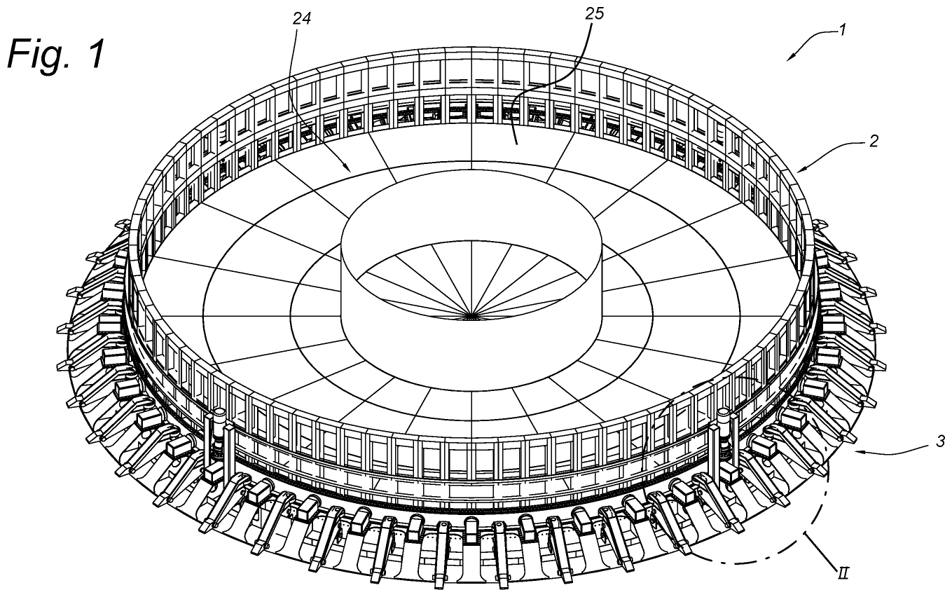

FIG. 1 shows in perspective view a cable turntable assembly 1. The cable turntable assembly 1 is configured for use in storing and laying long lengths of pipe or cable (not shown).

The cable turntable assembly 1 comprises a rotatable turntable 2. The turntable 2 has an accommodation 24 to store cable or pipe in a wound up state. The turntable 2 has a bottom member 25. The bottom member 25 is water tight.

The cable turntable assembly 1 comprises a turntable support surface 3. The turntable support surface 3 supports the turntable 2 for rotational movement. The turntable support surface 3 supports the turntable 2 for rotational movement around the vertical. Here, the turntable support surface 3 is a deck of a vessel.

The cable turntable assembly 1 comprises a fluid bearing system #. The fluid bearing system # is arranged between the rotatable turntable 2 and the turntable support surface 3. The fluid bearing system comprises a pressurized fluid chamber 4. Here, the fluid bearing system comprises one continuous pressurized fluid chamber 4. In this case, the pressurized fluid chamber extends over about 80% of the vertical projected surface of the turntable 2. The fluid bearing system comprises a sealing system 5. The sealing system 5 comprises a sealing element 6. The sealing element 6 extends at a circumference 7 of the turntable 2. The sealing elements 6 seals an annular gap 8 between the turntable support surface 3 and the turntable 2. The sealing elements 6 contacts the bottom of the turntable 2.

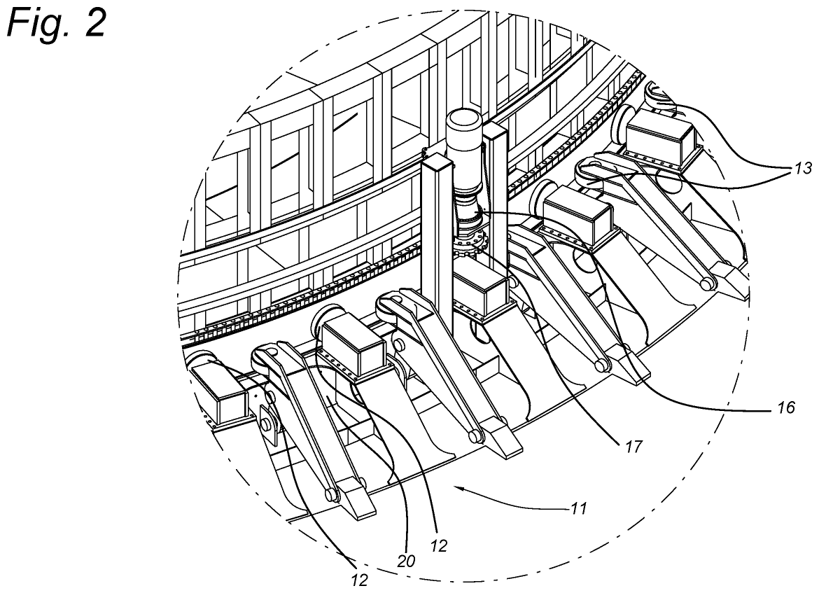

FIG. 2 shows a detail of FIG. 1. It can be seen that the cable turntable assembly comprises a stop arrangement 11. The stop arrangement 11 maintains a position of the turntable relative to the turntable support surface. The stop arrangement 11 comprises a number of axially working stop elements 12. The axially working stop elements 12 are spatially distributed along the outer circumference of the rotatable turntable 2. Here, the stop elements 12 contact the turntable in a rolling manner. The turntable 2 is prevented from moving upwards by the axially working stop elements 12. The turntable 2 is prevented from moving sideways by horizontal wheels 13 secured to the deck.

The stop arrangement 11 comprises a number of radially working stop elements 13. The radially working stop elements 13 are spatially distributed along the outer circumference of the rotatable turntable 2. The turntable 2 is prevented from moving sideways by horizontal wheels mounted directly on deck. Here, the stop elements 13 contact the turntable in a rolling manner.

The cable turntable assembly comprises a driving system 16. The driving system 16 rotates the turntable 2 to unwind or wind up, in other words pay out or take in cable or pipe. Here, the driving system 16 comprises a driving wheel 17, in this case a toothed wheel.

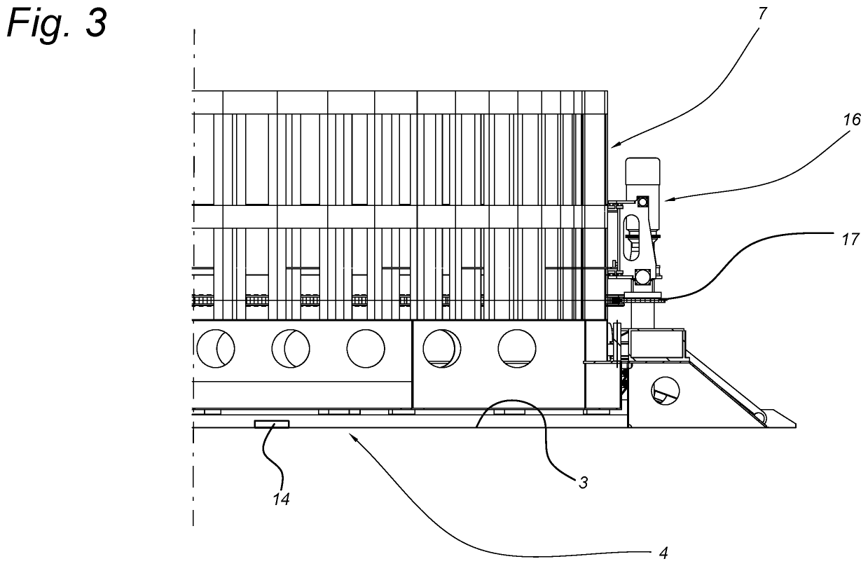

FIG. 3 is a side view of the cable turntable assembly of FIG. 1. The fluid bearing system comprises a pressurized fluid chamber 4. Here it can be best seen that the fluid bearing system comprises one continuous pressurized fluid chamber 4. In this case, the pressurized fluid chamber extends over about 80% of the perpendicular to the horizontal plane projected surface of the turntable 2.

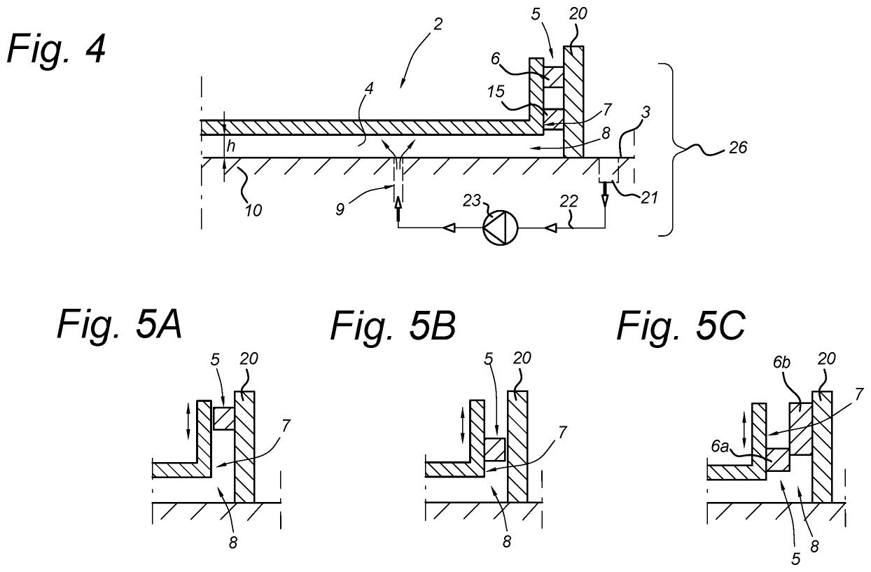

FIG. 4 shows a detail of an embodiment of the sealing system 5. The annular gap 8 extends between the outer circumference 7 of the turntable 2 and a watertight barrier 20. The water barrier 20 extends around the turntable 2. The water barrier extends 20 transverse with respect to the turntable support surface 3. The height of the water barrier 20 is about 1 meter compared to a height of about 4 meter of the turntable 2. FIG. 5a-c show possible arrangements of sealing element(s) between the outer circumference 7 of the turntable 2 and the watertight barrier 20. The cable turntable assembly 1 comprises an inlet 9. Pressurized fluid is supplied to the pressurized fluid chamber 4 through the inlet. Here, the inlet 9 is connected to the turntable support surface 3. The height h, referenced to with number 10, of the pressurized fluid chamber 4 is configured for accommodating deviations of the turntable support surface 3 and the turntable 2. In this case, the height of the pressurized fluid chamber is between about 5 cm to up to about 30 cm when the turntable is in its active height position as shown in FIGS. 3, 4 and 5a-c. The sealing system 5 may comprise a spacer 14. The spacer is arranged between the turntable support surface 3 and the turntable 2. The spacer 14 provides a failsafe stop for the turntable 2. Here, the sealing system 5 comprises two sealing elements 6, 15. The two sealing elements 6, 15 operate in series.

The cable turntable assembly has a bearing fluid recirculating system. A possible leakage flow 20 may leak through the sealing system 5. The sealing system 5 has a reservoir 21 to receive the leakage flow 20. The reservoir extends at the circumference of the turntable 2. The received leakage flow may be forced back to the inlet 9 of the sealing system 5. Here, a pump 23 forces the received leakage flow back to the pressurized fluid chamber 4 through a conduit 22.

The fluid bearing system is referenced to with number 26. The turntable support surface 3, the pressurized fluid chamber 4 and the sealing system 5 do form the fluid bearing system 26.

In FIG. 5a shows a sealing system 5. The sealing element 6 is connected to the water barrier 20.

In FIG. 5b shows a sealing system 5. The sealing element 6 is connected to the turntable 2.

In FIG. 5c shows a sealing system 5. The sealing element 6a is connected to the water barrier 20. The sealing element 6b is connected to the turntable 2.

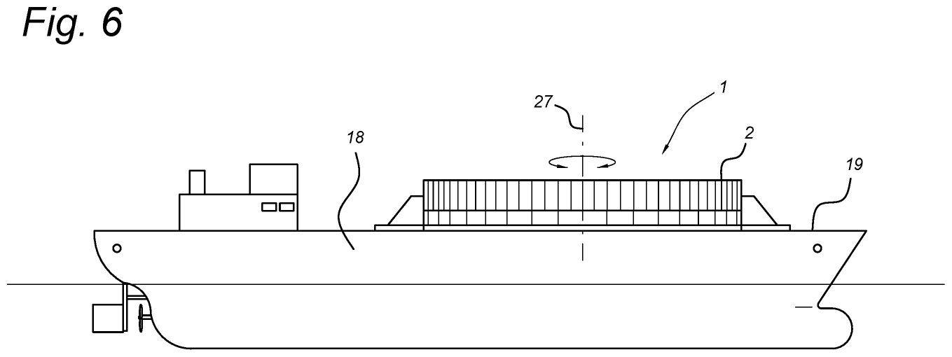

FIG. 6 shows a vessel 18 comprising a cable turntable assembly 1 according to the invention. The turntable support surface comprises a deck 19 of the vessel 18. The turntable 2 is rotatable about its central vertical axis 27.

The present invention has been described above with reference to a number of exemplary embodiments as shown in the drawings. Modifications and alternative implementations of some parts or elements are possible, and are included in the scope of protection as defined in the appended claims.

1. A cable turntable assembly for use in storing and laying long lengths of pipe or cable, comprising:
A rotatable turntable,
a turntable support surface supporting the turntable for rotational movement,
a fluid bearing system between the rotatable turntable and the turntable support surface, the fluid bearing system comprising a pressurized fluid chamber and a sealing system comprising a sealing element extending at a circumference of the turntable to seal an annular gap at the outer circumference of the turntable, and
a watertight barrier that extends around the turntable and transverse with respect to the turntable support surface,
wherein the annular gap extends between the outer circumference of the turntable and the watertight barrier.

2. The cable turntable assembly according to claim 1, wherein the pressurized fluid chamber extends over at least 80% of the perpendicular to the horizontal plane projected surface of the turntable.

3. The cable turntable assembly according to claim 1, wherein the pressurized fluid chamber is sectioned.

4. The cable turntable assembly according to claim 1, comprising an inlet for supplying pressurized fluid to the pressurized fluid chamber.

5. The cable turntable assembly according to claim 4, wherein the inlet is connected to the turntable support surface.

6. The cable turntable assembly according to claim 1, wherein the sealing element is dimensionally stable.

7. The cable turntable assembly according to claim 1, wherein the sealing system is connected to the turntable and/or the watertight barrier.

8. The cable turntable assembly according to claim 1, wherein a height of the pressurized fluid chamber is configured for accommodating deviations of the turntable support surface and the turntable.

9. The cable turntable assembly according to claim 8, wherein the height of the pressurized fluid chamber is between between about 5 cm to up to about 30 cm.

10. The cable turntable assembly according to claim 1, comprising a stop arrangement for maintaining a position of the turntable relative to the turntable support surface.

11. The cable turntable assembly according to claim 10, wherein the stop arrangement comprises a number of axially working stop elements spatially distributed along the outer circumference of the rotatable turntable, wherein the number of axially working stop elements define an active height position of the turntable when the pressurized fluid chamber is pressurized.

12. The cable turntable assembly according to claim 10, wherein the stop arrangement comprises a number of radially working stop elements spatially distributed along the outer circumference of the rotatable turntable.

13. The turntable assembly according to claim 1, wherein the sealing system comprises a spacer between the turntable support surface and the turntable

14. The cable turntable assembly according to claim 1, wherein the sealing system comprises two sealing elements operating in series.

15. The cable turntable assembly according to claim 1, comprising a driving system for rotating the turntable, wherein the driving system comprises a driving wheel.

16. The cable turntable assembly according to claim 1, comprising a bearing fluid recirculating system.

17. A vessel comprising a cable turntable assembly according to claim 1.

18. The vessel according to claim 17, wherein the turntable support surface comprises a deck of the vessel.
